(19) United States
(12) Patent Application Publication
(10) Pub. No.: US 2024/0045399 A1
(43) Pub. Date: Feb. 8, 2024

(54) ANALYSIS OF MULTI-RUN CYCLIC PROCESSING PROCEDURES

(71) Applicant: Applied Materials, Inc., Santa Clara, CA (US)

(72) Inventors: Qinglin Chai, Singapore (SG); Yue Ma, Wuhan City (CN); Liming Zhang, San Jose, CA (US); Xinhai Han, Palo Alto, CA (US); Chuan Ying Wang, San Jose, CA (US)

(21) Appl. No.: 18/038,441

(22) PCT Filed: May 17, 2022
(86) PCT No.: PCT/CN2022/093379

§ 371 Date: May 23, 2023

(51) Int. Cl. G05B 19/4099

(52) U.S. Cl. CPC G05B 19/4099; G05B 2219/45031

(57) ABSTRACT

A method includes receiving time trace sensor data associated with a substrate processing procedure. The substrate processing procedure includes two or more sets of processing conditions. At least a first set of processing conditions and a second set of processing conditions each include one or more operations performed repeatedly. The method further includes separating a first and second portion of the time trace sensor data corresponding to the first and second sets of processing conditions into a first and second plurality of cycle data. The method further includes processing the first plurality of cycle data and the second plurality of cycle data to generate summary data. The method further includes providing an alert to a user. The alert is based on the summary data.

### TECHNICAL FIELD

The present disclosure relates to diagnostic methods for analyzing sensor data associated with processing procedures, and more specifically, diagnostic methods for analyzing sensor data associated with multi-run processing procedures including cyclic and/or looped operations.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Understanding and controlling properties within the manufacturing chamber aids in consistent production of products.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In an aspect of the present disclosure, a method includes receiving time trace sensor data associated with a substrate processing procedure. The substrate processing procedure includes two or more sets of processing conditions. A first set of processing conditions and a second set of processing conditions each include one or more operations performed repeatedly. The method further includes separating a first portion of the time trace sensor data associated with the first set of processing conditions into a first plurality of cycle data. Each of the first plurality of cycle data is associated with one or more operations that are performed repeatedly. The method further includes separating a second portion of the time trace sensor data corresponding to the second set of processing conditions into a second plurality of cycle data. Each of the second plurality is associated with one or more operations performed repeatedly. The method further includes processing the first plurality of cycle data and the second plurality of cycle data to generate summary data. The method further includes providing an alert to a user. The alert is based on the summary data.

In another aspect of the disclosure, a system includes memory and a processing device coupled to the memory. The processing device is configured to receive time trace sensor data associated with a substrate processing procedure. The substrate processing procedure includes two or more sets of processing conditions. A first set of processing conditions and a second set of processing conditions each include one or more operations performed repeatedly. The processing device is further configured to separate a first portion of the time trace data associated with the first set of processing conditions into a first plurality of cycle data. Each of the first plurality of cycle data is associated with one or more operations that are performed repeatedly. The processing device is further configured to separate a second portion of the time trace sensor data associated with the second set of processing conditions into a second set of cycle data. Each of the second plurality is associated with one or more operations performed repeatedly. The processing device is further configured to process the first plurality of cycle data and the second plurality of cycle data to generate summary data. The processing device is further configured to provide an alert to a user based on the summary data.

In another aspect of the disclosure, a non-transitory machine-readable storage medium stores instructions. The instructions, when executed, cause a processing device to perform operations. The operations include receiving time trace sensor data associated with a substrate processing procedure. The substrate processing procedure includes two or more sets of processing conditions. A first set of processing conditions and a second set of processing conditions each include one or more operations performed repeatedly. The operations further include separating a first portion of the time trace sensor data corresponding to the first set of processing conditions into a first plurality of cycle data. Each of the first plurality of cycle data is associated with one or more operations that are performed repeatedly. The operations further include separating a second portion of the time trace sensor data corresponding to the second set of processing conditions into a second plurality of cycle data. Each of the second plurality is associated with one or more operations performed repeatedly. The operations further include processing the first plurality of cycle data and the second plurality of cycle data to generate summary data. The method further includes providing an alert to a user. The alert is based on the summary data.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts an exemplary data flow 200 for generating an alert based on summary data, according to some embodiments.

FIG. 3 depicts a visualization of operations for splitting trace data into transient and steady-state portions, according to some embodiments.

FIG. 4 depicts exemplary dashboard for alerting a user to quality of performance of one or more processing procedures, according to some embodiments.

FIG. 5 depicts a flow diagram of a method for generating an alert based on a looped processing procedure, according to some embodiments.

FIG. 6 is a block diagram illustrating a computer system, according to some embodiments.

### DETAILED DESCRIPTION

Described herein are technologies related to diagnostic methods for multi-stage looping manufacturing operations, which may be used for diagnosing problems in manufacturing equipment and/or for performance of a corrective action. Manufacturing equipment may be used to produce products, such as substrates (e.g., wafers, semiconductors, displays, photovoltaics, etc.). Manufacturing equipment (e.g., manufacturing tools) often includes a processing chamber that separates the substrate being processed from the environment. The properties of produced substrates are to meet target property values to facilitate performance, functionality, etc. Anomalies, drift, or other differences in processing environment may generate substrates with sub-optimal performance, e.g., semiconductors that fail to function as intended, inefficiencies in manufacturing (for example, additional expenditure of time, materials, energy, etc.). A processing environment may be quantified by various sensors associated with a processing chamber, e.g., pressure gauges, temperatures sensors, sensors indicative of electrical power (e.g., voltmeters, etc.), gas flow meters, etc.

In some systems, a processing procedure may include a series of repeated (e.g., looped, cyclic) operations. For example, a target substrate may include a series of layers stacked on top of one another. Such structures may be generated, for example, by repeated deposition operations, such as staircase deposition operations. In some embodiments, a target substrate configuration may include many layers, e.g., dozens of layers, hundreds of layers, etc. In such systems (e.g., including looped operations), analysis of sensor data for anomaly detection, drift detection, equipment or product health evaluation, etc., may be cumbersome. The repeated operations may be indicated by repeated patterns in sensor data, which may be difficult to analyze utilizing traditional methods (e.g., statistical metrics). Additionally, identifying a potentially problematic layer may be cumbersome amidst the plurality of looped operations reflected in sensor data.

In some systems, a processing procedure may include a series of processing runs, e.g., a series of runs including different processing conditions, a series of runs between which the substrate is removed from the processing chamber, etc. Separate processing runs associated with the same substrate complicates data analysis procedures. In conventional systems, each processing run may be examined individually, e.g., to find evidence of errors, faults, poor performance, etc. Some systems include multiple processing runs which themselves include looped operations, compounding analysis inefficiencies.

In some systems, investigations into sensor data may be triggered by sub-optimal performance, e.g., by one or more products being produced with properties outside of manufacturing specifications. In some cases, only a subset of products undergo performance measurements, e.g., metrology measurements to ascertain production quality. Performance measurements (e.g., metrology) may be costly, e.g., may take a significant amount of time to generate. Manufacturing equipment may continue to be used to produce products while metrology is performed on other products and/or while products are in queue for metrology measurements. In cases where manufacturing equipment has degenerated (e.g., changed such that performance of the equipment is sub-optimal, such as due to components aging, drifting, failing, etc.), metrology measurements of products may not be performed until after a number of products have been processed using the sub-optimal equipment. As a result sub-optimal products may be manufactured. Such a system is wasteful in terms of wasted time processing sub-optimal products, energy expended, materials expended, etc.

In conventional systems, the difficulties in isolating informative sensor data (e.g., identifying from a large amount of sensor data, data indicating a corrective action to be performed in association with manufacturing equipment) results in a metrology-based fault detection. In some cases, sensor data may be affected in an observable way by drifting, aging, or failing components earlier than metrology is observably affected. In such a case, sensor data may be used to schedule a corrective action to coincide with planned downtime (e.g., a preventative maintenance operation) before metrology is affected, reducing expensive unscheduled downtime for the manufacturing system. If sensor data cannot be reliably used, corrective actions may be performed responsive to sub-optimal metrology data and may result in unscheduled downtime. In some embodiments unscheduled downtime may incur additional costs, such as express shipping for replacement components, etc.

Methods and devices of the present disclosure may address one or more of the above described deficiencies in conventional solutions. In some embodiments, summary data is enabled and generated that allows quick processing time, utilization of standard statistical methods in complex looping procedures, a reduction in communication bandwidth, mitigation of complexity of analyzing full trace data, etc. Generating summary data may include application of statistical methods, machine learning methods, digital twin methods, etc., to trace data (e.g., trace sensor data).

One or more metrics (e.g., standards of measurement) may be utilized to indicate system health of manufacturing equipment. In some embodiments, summary data may be utilized to generate one or more metric values. A metric value may be used as an indication that further investigations are to be implemented, associated with a chamber, a process, a product, a component, etc. In some embodiments, a metric value (e.g., an index, a quality score, a statistical value, etc.) may be calculated and compared to a second value, e.g., a value associated with a golden run (e.g., a processing run selected where acceptable processing conditions were achieved), an average value of several processing runs, etc. In some embodiments, multiple metrics may be generated (e.g., several statistical measures, several metrics associated with one or more shapes in trace data, etc.). In some embodiments, each loop/cycle (or collection of loops, in some embodiments) may be associated with a set of metric values.

Analysis results of the looped procedure may be used to generate an alert for a user. For example, analysis results may be displayed on a dashboard (e.g., a graphical user interface). In some embodiments, the graphical user interface may include a graphical user interface element displaying data associated with the cyclic procedure. Analysis results may be displayed to indicate potentially faulty layers of a substrate, e.g., results may display a chosen metric (e.g., summary data) as a function of tier/layer number, results may be displayed with different tiers plotted as different colors on a gradient, etc. Displayed analysis results may include data from tiers generated across multiple processing runs, may include multiple wafers (e.g., for comparison), etc.

Aspects of the present disclosure result in technological advantages compared to conventional solutions. The present disclosure results in a more efficient substrate manufacturing process with minimized waste. If a problem arises in association with a processing chamber, methods of the present disclosure may be able to cause performance of a corrective action before processing of the next product has begun, before a sub-optimal product is submitted for quality measurements, before quality measurements are completed, etc. In this way, wasted material, manufacturing chamber time, and energy supplied to the manufacturing process can be minimized. Additionally, methods of the present disclosure may reduce resolution time, e.g., time elapsed between recognition that a problem with a processing chamber exists, and resolution of the problem (e.g., via identification of a component to replace, maintenance to perform, recipe adjustment to make, etc.). Product quality may increase, as root causes of variations in product quality and chamber drift may be identified and corrected. The efficiency of producing products of acceptable quality may also increase, as the process parameters can be tuned more precisely, improving cost of materials, energy, and time. Aging components may be identified and flagged for replacement or maintenance, reducing unscheduled down time, costs associated with express shipping replacement parts, and the like.

In some embodiments, the present disclosure describes a method, including receiving time trace sensor data associated with a substrate processing procedure. The substrate processing procedure includes two or more sets of processing conditions. A first set of processing conditions and a second set of processing conditions each include one or more operations performed repeatedly. The method further includes separating a first portion of the time trace sensor data corresponding to the first set of processing conditions into a first plurality of cycle data. Each of the first plurality of cycle data is associated with one or more operations that are performed repeatedly. The method further includes separating a second portion of the time trace sensor data corresponding to the second set of processing conditions into a second plurality of cycle data. Each of the second plurality is associated with one or more operations performed repeatedly. The method further includes processing the first plurality of cycle data and the second plurality of cycle data to generate summary data. The method further includes providing an alert to a user. The alert is based on the summary data.

In another aspect of the disclosure, a system includes memory and a processing device coupled to the memory. The processing device is configured to receive time trace sensor data associated with a substrate processing procedure. The substrate processing procedure includes two or more sets of processing conditions. A first set of processing conditions and a second set of processing conditions each include one or more operations performed repeatedly. The processing device is further configured to separate a first portion of the time trace data corresponding to the first set of processing conditions into a first plurality of cycle data. Each of the first plurality of cycle data is associated with one or more operations that are performed repeatedly. The processing device is further configured to separate a second portion of the time trace sensor data corresponding to the second set of processing conditions into a second set of cycle data. Each of the second plurality is associated with one or more operations performed repeatedly. The processing device is further configured to process the first plurality of cycle data and the second plurality of cycle data to generate summary data. The processing device is further configured to provide an alert to a user based on the summary data.

In another aspect of the disclosure, a non-transitory machine-readable storage medium stores instructions. The instructions, when executed, cause a processing device to perform operations. The operations include receiving time trace sensor data associated with a substrate processing procedure. The substrate processing procedure includes two or more sets of processing conditions. A first set of processing conditions and a second set of processing conditions each include one or more operations performed repeatedly. The operations further include separating a first portion of the time trace sensor data corresponding to the first set of processing conditions into a first plurality of cycle data. Each of the first plurality of cycle data is associated with one or more operations that are performed repeatedly. The operations further include separating a second portion of the time trace sensor data corresponding to the second set of processing conditions into a second plurality of cycle data. Each of the second plurality is associated with one or more operations performed repeatedly. The operations further include processing the first plurality of cycle data and the second plurality of cycle data to generate summary data. The method further includes providing an alert to a user. The alert is based on the summary data.

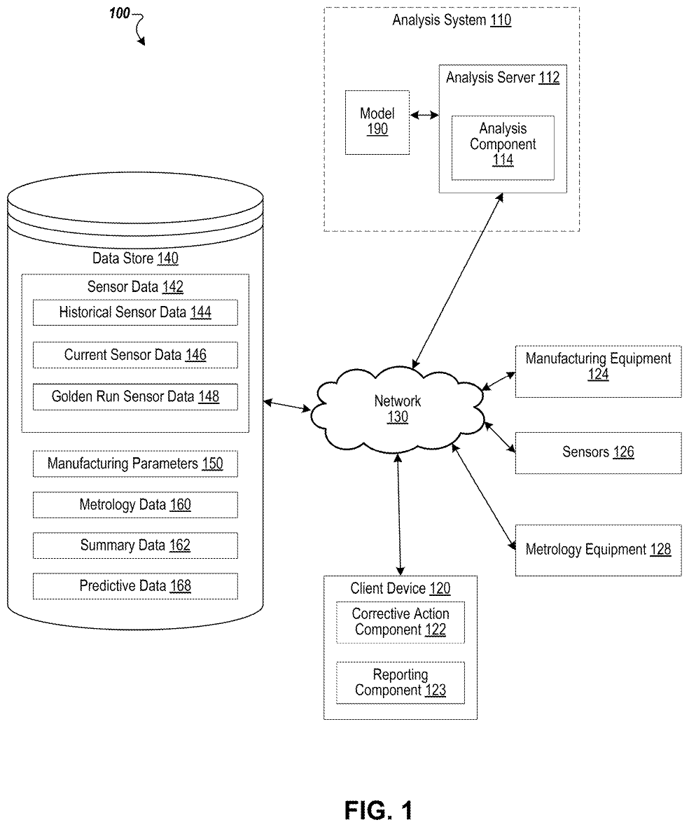

FIG. 1 is a block diagram illustrating an exemplary system 100 (exemplary system architecture), according to some embodiments. System 100 includes a client device 120, manufacturing equipment 124, sensors 126, metrology equipment 128, an analysis server 112, and a data store 140. Analysis server 112 may be part of an analysis system 110.

Sensors 126 may provide sensor data 142 associated with manufacturing equipment 124 (e.g., associated with producing, by manufacturing equipment 124, corresponding products, such as substrates). Sensor data 142 may be used for ascertaining equipment health and/or product health (e.g., product quality). Manufacturing equipment 124 may produce products following a recipe or performing runs over a period of time. In some embodiments, sensor data 142 may include values of one or more of temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may be associated with or indicative of manufacturing parameters such as hardware parameters (e.g., settings or components, e.g., size, type, etc.) of manufacturing equipment 124 or process parameters of manufacturing equipment 124. Data associated with some hardware parameters may, instead or additionally, be stored as manufacturing parameters 150. Manufacturing parameters 150 may be indicative of input settings to the manufacturing device (e.g., heater power, gas flow, etc.). Sensor data 142 and/or manufacturing parameters 150 may be provided while manufacturing equipment 124 is performing manufacturing processes (e.g., may be equipment readings generated during processing of substrates). Sensor data 142 may be different for each product (e.g., each substrate). Substrates may have property values (e.g., film thickness, film strain, etc.) measured by metrology equipment 128. Metrology data 160 may be a type of data stored in data store 140.

In some embodiments, sensor data 142, metrology data 160, and/or manufacturing parameters 150 may be processed (e.g., by the client device 120 and/or by the analysis server 112). Processing of sensor data 142, metrology data 160, and/or manufacturing parameters 150 may include generating features. In some embodiments, the features are a pattern in the sensor data 142, metrology data 160, and/or manufacturing parameters 150 (e.g., slope, width, height, peak, etc.) or a combination of values from the sensor data 142, metrology data 160, and/or manufacturing parameters 150 (e.g., power derived from voltage and current, etc.). Sensor data 142 may include features and the features may be used by the analysis component 114 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. Data store 140 may further store information associating sets of different data types, e.g. information indicative that a set of sensor data, a set of metrology data, and a set of manufacturing parameters are all associated with the same product, manufacturing equipment, type of substrate, etc.

In some embodiments, data associated with processing of one or more products may be used to generate summary data 162. Summary data 162 may include data that represents features of other data. For example, summary data 162 may be generated from trace sensor data 142. Trace sensor data 142 may include a large amount of data (e.g., data from hundreds of sensors in a tool, each taking hundreds or thousands of measurements per product, etc.). Summary data 162 may be less cumbersome to manipulate than trace sensor data 142, and may be designed in a way that information (e.g., information indicative of a chamber fault) may be preserved. In some embodiments, data (e.g., trace sensor data 142) may be provided to a processing device (e.g., analysis server 112, client device 120, etc.) to generate summary data 162.

Summary data 162 may include, for example, metadata (e.g., tool ID, recipe name, product ID, product information, etc.), context data (e.g., sensor ID, step number, time stamp, subsystem, etc.), and/or basic statistics (e.g., mean, maximum, minimum, quartiles, kurtosis, control limits, etc.). Summary data 162 may include statistical metrics of looped operations of a processing procedure. For example, analysis system 110 may separate trace sensor data into repeated portions (e.g., loops, substrate layers or tiers, sets of a number of loops, etc.). Separated trace sensor data may then be utilized to generate summary data, which may be indicative of product or system health or quality.

Summary data 162 may include indications of how features of the measured data differ from the predictions of a model system, such as a golden run (e.g., overshoot, rise time, settle time, steady state value error, etc.). In some embodiments, summary data 162 may be generated based on part of the input data, e.g., only a steady state portion, only a transient portion, etc. of the summary data 162.

In some embodiments, analysis system 110 may generate predictive data 168 using machine learning, such as supervised machine learning (e.g., a machine learning model may be configured to produce labels associated with input data, such as metrology predictions, performance predictions, etc.). In some embodiments, analysis system 110 may generate predictive data 168 using unsupervised machine learning (e.g., a machine learning model may be trained with unlabeled data, such as a model configured to perform clustering, dimensional reduction, etc.). In some embodiments, analysis system 110 may generate predictive data 168 using semi-supervised learning (e.g., a machine learning model may be trained using both labeled and unlabeled input data sets).

Client device 120, manufacturing equipment 124, sensors 126, metrology equipment 128, analysis server 112, and data store 140 may be coupled to each other via network 130 for generating predictive data 168 to perform corrective actions.

In some embodiments, network 130 is a public network that provides client device 120 with access to the analysis server 112, data store 140, and other publicly available computing devices. In some embodiments, network 130 is a private network that provides client device 120 access to manufacturing equipment 124, sensors 126, metrology equipment 128, data store 140, and other privately available computing devices. In some embodiments, the functions of one or more of client device 120 and/or analysis server 112 may be performed by a virtual machine, e.g., utilizing a cloud-based service. Network 130 may provide access to such virtual machines. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include a computing device such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. The client device 120 may include a corrective action component 122. Corrective action component 122 may receive user input (e.g., via a Graphical User Interface (GUI) displayed via the client device 120) of an indication associated with manufacturing equipment 124. Client device 120 may include reporting component 123. Reporting component 123 may display an alert (e.g., a performance report) for a user associated with performance of manufacturing equipment 124, quality of a substrate, quality of a process, etc. In some embodiments, corrective action component 122 transmits the indication to analysis system 110, receives an output (e.g., predictive data 168) from analysis system 110, determines a corrective action based on the output, and causes the corrective action to be implemented (e.g., by providing an alert to a user via reporting component 123). In some embodiments, corrective action component 122 obtains sensor data 142 (e.g., current sensor data 146) associated with the manufacturing equipment 124 (e.g., from data store 140, etc.) and provides sensor data 142 (e.g., current sensor data 146) associated with manufacturing equipment 124 to analysis system 110. In some embodiments, corrective action component 122 stores sensor data 142 in data store 140 and analysis server 112 retrieves sensor data 142 from data store 140. In some embodiments, analysis server 112 may store an output (e.g., predictive data 168) of model 190 in data store 140 and client device 120 may retrieve the output from data store 140. In some embodiments, corrective action component 122 receives an indication of a corrective action from analysis system 110 and causes the corrective action to be implemented. Each client device 120 may include an operating system that allows users to one or more of generate, view, or edit data (e.g., an indication associated with manufacturing equipment 124, corrective actions associated with manufacturing equipment 124, etc.).

In some embodiments, metrology data 160 corresponds to historical property data of products (e.g., produced using manufacturing parameters associated with historical sensor data 144 and historical manufacturing parameters). Predictive data 168 may include analysis results, e.g., output of analysis system 110, predicted system failure, corrective actions to be performed, maintenance to be performed, etc. In some embodiments, predictive data 168 is an indication of abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into analysis system 110, receiving output of predictive data 168, and performing a corrective action based on the predictive data 168, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting sensor data 142 (e.g., indicative of manufacturing parameters that are being used or are to be used to manufacture a product) into analysis system 110, receiving output of predictive data 168, and performing corrective action (e.g., predicted operational maintenance, such as replacement, processing, cleaning, etc. of components) based on predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing parameters may be sub-optimal for producing product, which may have costly results of increased resource (e.g., energy, coolant, gases, etc.) consumption, increased amount of time to produce the products, increased component failure, increased amounts of defective products, etc. By inputting the sensor data 142 into analysis system 110, receiving an output of predictive data 168, and performing (e.g., based on the predictive data 168) a corrective action of updating manufacturing parameters (e.g., setting optimal manufacturing parameters), system 100 can have the technical advantage of using optimal manufacturing parameters (e.g., hardware parameters, process parameters, optimal design) and/or healthy equipment to avoid costly results of sub-optimal manufacturing parameters.

Corrective action may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process on additional substrates if the predictive data 168 indicates a predicted abnormality, such as an abnormality of the product, a component, or manufacturing equipment 124). In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters.

Manufacturing parameters may include hardware parameters (e.g., information indicating components included in the manufacturing equipment, indications of recently replaced components, indications of firmware versions or updates, etc.) and/or process parameters (e.g., temperature, pressure, flow rate, electrical current and/or voltage, gas flow, lift speed, etc.). In some embodiments, the corrective action includes causing preventative operative maintenance (e.g., to replace, process, clean, etc. components of the manufacturing equipment 124). In some embodiments, the corrective action includes causing design optimization (e.g., updating manufacturing parameters, updating manufacturing processes, updating manufacturing equipment 124, etc. for an optimized product). In some embodiments, the corrective action includes updating a recipe (e.g., altering timing of instructions for manufacturing equipment 124 to be in an idle mode, a sleep mode, a warm-up mode, etc., adjusting set points for temperature, gas flow, plasma generation, etc.).

Analysis server 112 may include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Analysis server 112 may include an analysis component 114. In some embodiments, analysis component 114 may receive current sensor data 146, and/or current manufacturing parameters (e.g., receive from the client device 120, retrieve from the data store 140) and generate output (e.g., predictive data 168) for performing a corrective action associated with manufacturing equipment 124 based on the current data. In some embodiments, analysis component 114 may use one or more trained models 190 to determine the output for performing the corrective action based on current data.

In some embodiments, model 190 may include a trained physics-based digital twin model. The physics-based model may be capable of solving systems of equations describing physical phenomena that may occur in the manufacturing chamber, such as equations governing heat flow, energy balance, gas conductance, mass balance, fluid dynamics, electrical current flow, or the like. In some embodiments, the physics-based model performs calculations of component performance in the manufacturing chamber. Manufacturing parameters 150 may be provided to the trained physics-based model. The trained physics-based model may provide as output modeled property values indicative of conditions within the chamber, corresponding to sensors 126 disposed within the manufacturing chamber (e.g., manufacturing equipment 124). The output of the physics-based model may be stored in data store 140.

Analysis component 114 of analysis server 112 may receive sensor data 142 generated from data collected by sensors 126. Analysis component 114 may utilize sensor data 142 to generate summary data 162, predictive data 168, etc. Summary data 162 may include metrics indicative of equipment performance. For example, analysis component 114 may retrieve trace sensor data (e.g., current sensor data 146) from data store 140. Analysis component 114 may separate data from processing runs into shorter portions, e.g., individual loops, looped operations, etc. Analysis component 114 may then generate summary data (e.g., by providing data to model 190) indicative of quality of performance of processing operations.

In some embodiments, analysis component 114 may generate a series of sets of trace data associated with the looping process. For example, each set of data may be associated with one loop, one operation, etc. In some embodiments, one or more sets of trace data of a certain type (e.g., all oxide deposition operations, one or more nitride deposition operations, one or more post-deposition pump and/or purge operations, etc.) may be grouped together for analysis, display, etc.

In some embodiments, a set of trace data (e.g., as generated in series by analysis component 114) may include one or more portions of transient data (e.g., associated with periods of ramping processing parameters, associated with periods where target processing conditions have not been reached, etc.) and one or more portions of steady-state data (e.g., associated with periods of time where target processing conditions are to be maintained). Analysis system 110 (e.g., via model 190) may separate sets of trace data into transient and steady-state portions. Separation into transient and steady-state portions is discussed in more detail in connection with FIG. 3. In some embodiments, analysis system 110 may utilize steady-state portions to generate summary data 162, e.g., analysis system 110 may generate statistical metrics from steady-state data such as mean, median, standard deviation, etc. In some embodiments, analysis system 110 may utilize transient portions to generate summary data 162, e.g., analysis system 110 may compare transient data metrics to golden run data, to physics-based model data, to average data, etc. Analysis system 110 may utilize machine learning models (e.g., model 190) to determine whether differences exist between a transient portion of data and historical transient data. Analysis system 110 may utilize features of transient data, e.g., shapes in transient data such as spikes, ramps, slopes, etc.; measures such as slope, concavity, etc., of transient data, or the like, to determine summary data 162.

In some embodiments, sensor data 142 may include data collected from sensors 126 during a manufacturing run that produced an acceptable product (e.g., as measured by metrology equipment 128). A manufacturing run that produces an acceptable product may be referred to as a golden run. In some embodiments, a golden run may be determined differently, e.g., a run where acceptable chamber conditions were achieved, a run that occurred soon after chamber maintenance or new chamber installation, etc. Sensor data associated with such a manufacturing run may be stored in data store 140 as golden run sensor data 148. Analysis component 114 of analysis server 112, reporting component 123 of client device 120, or the like, may compare golden run sensor data, current sensor data 146, and expected sensor data (e.g., as output by the trained physics-based model) to determine if component failure, drift, or the like has occurred. In some embodiments, some or all of these operations may instead be performed by a different device, e.g., operations ascribed to analysis server 112 may instead be performed by client device 120, etc.

In some embodiments, analysis component 114 receives current sensor data 146 and/or current manufacturing parameters, performs signal processing to break down the current data into sets of current data, provides the sets of current data as input to a trained model 190, and obtains outputs indicative of predictive data 168 from the trained model 190. In some embodiments, predictive data 168 is indicative of metrology data 160 (e.g., prediction of substrate quality). In some embodiments, predictive data 168 is indicative of component health. In some embodiments, predictive data 168 is indicative of component performance. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, summary data 162, and predictive data 168. Sensor data 142 may include historical sensor data 144, current sensor data 146, and golden run sensor data 148. Sensor data may include sensor data time traces over the duration of manufacturing processes, associations of data with physical sensors, pre-processed data, such as averages and composite data, and data indicative of sensor performance over time (i.e., many manufacturing processes). Summary data 162 may include processed sensor data 142. Summary data may contain information indicative of corrective actions to be performed in association with manufacturing equipment 124. Summary data may be less intensive (e.g., less computationally expensive) to manipulate than trace sensor data.

Analysis component 114 may provide current sensor data 146 and/or summary data 162 to model 190 and may run model 190 on the input to obtain one or more outputs. Analysis component 114 may be capable of determining (e.g., extracting) predictive data 168 from the output of model 190 and may determine (e.g., extract) confidence data from the output that indicates a level of confidence that the predictive data 168 is an accurate predictor of a process associated with the input data for products produced or to be produced using the manufacturing equipment 124 at the current sensor data 146 and/or current manufacturing parameters 154. Analysis component 114 or corrective action component 122 may use the confidence data to decide whether to cause a corrective action associated with the manufacturing equipment 124 based on the predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) analysis component 114 may cause model 190 to be re-trained and/or reconfigured (e.g., based on current sensor data 146, current manufacturing parameters 154, etc.).

In some embodiments, the functions of client device 120 and predictive server 112 may be provided by a fewer number of machines. For example, in some embodiments, client device 120 and predictive server 112 may be integrated into a single machine.

In general, functions described in one embodiment as being performed by client device 120 or predictive server 112 can also be performed by the other of the two components in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from analysis system 110, etc.

In addition, the functions of a particular component can be performed by different or multiple components operating together. One or more of the predictive server 112, or client device 120 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, or the like.

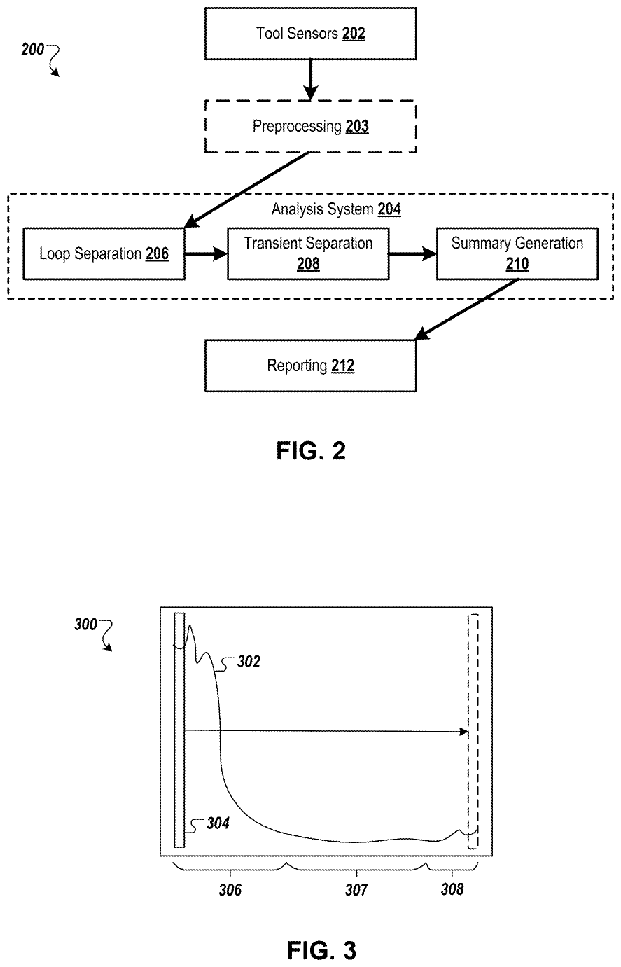

FIG. 2 depicts an exemplary data flow 200 for generating an alert based on summary data, according to some embodiments. Sensor data is generated by tool sensors 202. Tool sensors may include sensors disposed in a processing chamber, e.g., sensors 126 of FIG. 1. Tool sensors 202 may generate time trace sensor data, e.g., may take readings spaced throughout a duration associated with a processing procedure of the tool (e.g., processing chamber).

In some embodiments, the processing procedure may include one or more repeated (e.g., looped) operations. For example, the processing procedure may target an output substrate including layers and/or tiered structures. The processing procedure may include, for example, deposition of a first material via a first process gas, removal of the first process gas (e.g., via evacuation, inert gas flushing, etc.), deposition of a second material via a second process gas, and removal of the second process gas. Operations of the processing procedure may be repeated multiple times (e.g., dozens of times, hundreds of times, etc.) to generate a layered structure (e.g., layers may be formed as first material, second material, first material, second material, etc.). Repeated operations may be represented in the sensor data, e.g., chamber pressure may repeatedly rise and fall through gas introduction to and removal from the processing chamber, process gas flow meters may record repeated patterns of flow rates, etc.

In some embodiments, a processing procedure may be separated into processing runs. For example, a target substrate may include a number of tiers (e.g., 100 tiers). A first set of tiers (e.g., tiers 1-50) may target different properties (e.g., layer thickness, etc.) than a second set of tiers (e.g., tiers 51-100). In some embodiments, a substrate may be removed from a processing chamber and/or removed from processing conditions between runs. For example, a substrate may be rotated after a first set of tiers is deposited, e.g., to manage substrate stress and/or compensate for spatial irregularities in the deposition process.

Data may flow from tool sensors 202 to preprocessing module 203. In some embodiments, sensor data may be stored in memory and retrieved at a later time for preprocessing. In some embodiments, preprocessing operations may be performed by a different system (e.g., analysis system 204), at a different point in data flow 200 (e.g., after operations of loop separation 206, during operations of analysis & reporting 212, etc.).

Preprocessing 203 may include applying operations to sensor data. For example, preprocessing 203 may include smoothing, averaging, combining of sensor data (e.g., inferring quantities not directly measured using data from one or more sensors), or the like. In some embodiments, preprocessing 203 may include associating sensor data. For example, data from different sensors may be associated, data from multiple processing runs (e.g., sets of operations between which the substrate was removed from the processing chamber) may be associated, etc. In some embodiments, a processing device may correlate sets of data based on stored file names, e.g., file names may include a substrate ID, and the substrate ID may be used to correlate files together. In some embodiments, a processing device may correlate sets of data based on file generation time and/or tool ID.

Data is provided to analysis system 204. Analysis system 204 may correlate to analysis system 110 of FIG. 1. Analysis system 204 may process data (e.g., preprocessed time trace sensor data) utilizing a number of tools, modules, models, or the like. In some embodiments, data may be provided to loop separation module 206. Operations of loop separation 206 may include dividing preprocessed sensor data into a series of loops. For example, loop separation module 206 may divide sensor data into sets of data that each correspond to a layer of the processed substrate.

In some embodiments, processing logic (e.g., associated with loop separation module 206) may categorize a separated data set (e.g., associated with a single operation that is repeated, such as deposition of a first material). For example, each deposition of a first material from a processing run, processing procedure, etc., may be classified as the same operation, each deposition of a second material may be classified as a second operation, each evacuation of a first process gas may be classified as a second operation, etc. In some embodiments, processing logic may assign a classification based on values of sensor data, e.g., values recorded by key sensors. For example, flow meter readings from a flow meter measuring flow of a first process gas may be used to determine whether a processing operation corresponding to deposition of a first material associated with the first process gas. Multiple sensor readings may be utilized together to classify an operation, e.g., radio frequency power and gas flow readings may classify an etch operation. Sensor readings and sensor history may be utilized to classify an operation, e.g., a period of low pressure following a period classified as deposition of a first material may be classified as evacuation of a first processing gas associated with the first material. In some embodiments, output from loop separation module 206 may include a sequence of time trace data sets, collected by multiple sensors, separated into single operations, and classified by operation type.

In some embodiments, an index may be generated and associated with the loop data. The index may uniquely identify loops of a processing procedure, e.g., the index values may continue to increment across processing runs, across processing conditions, etc. In some embodiments, a target structure may include many layers, each with an assigned index. The index may be utilized in future operations, e.g., visualization operations may plot sensor data as a function of loop index, data associated with select indexed loop numbers of multiple out-of-control limit substrates may be compared, etc. In some embodiments, index values may act as unique identifiers for cycles of sensor data, loops of a multi-run process, etc.

Data may be received by transient separation module 208. A time trace data set received from loop separation module 206 may include one or more transient portions and one or more steady-state portions. For example, a deposition operation may begin with low processing chamber pressure, and process gas may be introduced until processing chamber pressure reaches a target value. Pressure sensor time trace data may include a period of transition from low pressure to target pressure. Transient separation module 208 may be configured to separate the transient portion from the steady state portion for further analysis. Operations of transient separation module 208 are described further in connection with FIG. 3.

Output of transient separation module 208 may be provided to summary data generation module 210. Summary data generation module 210 may be configured to receive processed trace sensor data and generate as output one or more summary data associated with the input data. Summary data generation module 210 may utilize one or more models (e.g., machine learning models, physics-based models, statistical models, exemplary model systems, including model 190 of FIG. 1) to generate summary data from processed trace data. In some embodiments, summary data generation may include calculating statistical metrics associated with steady-state data, e.g., mean, median, range, standard deviation, skew, etc.

In some embodiments, summary generation operations may be performed utilizing a transient portion of the processed trace data. In some embodiments, a transient portion of data may be provided to a trained machine learning model. The trained machine learning model may be configured to distinguish between normal and anomalous transient data. In some embodiments, transient data may be utilized for summary data generation by use of a physics-based model, exemplary model system (e.g., golden run data), etc. Features of a transient portion of data may be extracted and compared to model data. For example, features such as rise time (e.g., the time between beginning of a transient portion and reaching some portion of a target sensor reading value, such as 90%), overshoot (e.g., by how far the sensor data overshoots a target value), oscillation (e.g., whether a sensor value oscillates before settling to a target value, features of the oscillation such as frequency and amplitude, etc.), settle time (e.g., the time from the beginning of a transient portion to the final time that a sensor value was more than a defined interval from a target value, such as +/−10%), or the like may be compared to the model system to generate summary data. Techniques described herein for analysis of steady-state portions of data may be applied to transient portions. Techniques described for analysis of transient portions may be applied to steady-state analysis.

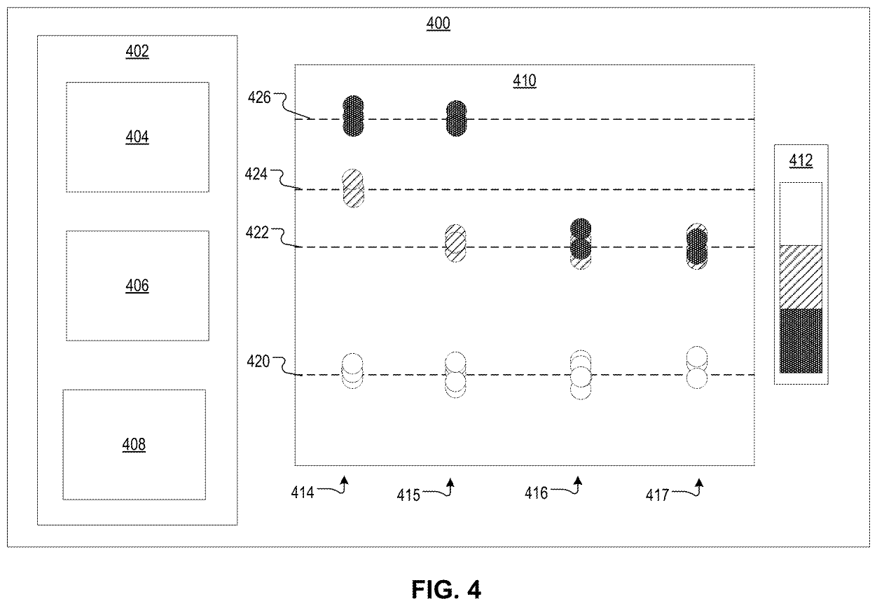

Data (e.g., including summary data) may then be provided to reporting module 212. Reporting module may be similar to reporting component 123 of client device 120 of FIG. 1. In some embodiments, reporting module 212 includes a dashboard (e.g., graphical user interface) for display of analysis, e.g., summary data. An exemplary dashboard is presented as FIG. 4. In some embodiments, reporting module 212 may receive multiple types of summary data, summary data associated with multiple sensors, etc. Reporting module 212 may include one or more interfacing tools, e.g., to select summary data to display, select sensor data to display, select substrate data to display, etc.

FIG. 3 depicts a visualization 300 of operations for splitting trace data into transient and steady-state portions, according to some embodiments. Visualization 300 includes a time trace 302. Time trace 302 may be associated with one sensor and one processing operation (e.g., a full run time trace has already been split, such as by loop separation module 206 of FIG. 2, to generate time trace 302). In some embodiments, the value of time trace 302 may be utilized to identify a steady-state portion, e.g., portions of time trace 302 within a determined threshold of a target value (such as within 10% of the target value) may be classified as steady-state portions. In some embodiments, a slope of data included in time trace 302 may be utilized to separate a transient from a steady-state portion. For example, a best fit function may be used to approximate time trace 302. A first derivative describing the slope of the best fit function may be calculated. Portions of time trace 302 with slopes (e.g., slope magnitude/absolute value) above a threshold may be classified as transient portions, and portions of time trace 302 with slopes below the threshold may be classified as steady-state portion.

In some embodiments, a window 314 may be utilized to determine if a set of data points (e.g., the data points within the window) belong to a transient or steady state portion of the data. A metric value of points within the window may be used to classify the points in the window as transient or steady state, e.g., range, standard deviation, variance, etc. For example, if window 314 includes points with a standard deviation of their values over a threshold, points within window 314 may be classified as belonging to a transient portion.

In some embodiments, window 304 is moved through the time trace to classify data points of the trace as transient or steady-state, as indicated by the arrow and dashed window at the right side of trace 302. In some embodiments, time trace 302 may be separated into two or more portions. In some embodiments, time trace 302 may be separated into a transient head portion 306, a steady state portion 307, and a transient tail portion 308.

FIG. 4 depicts exemplary dashboard 400 for alerting a user to quality of performance of one or more processing procedures, according to some embodiments. Dashboard 400 may be, include, be integrated with, etc., a graphical user interface (GUI). Dashboard 400 may include control panel 402 and data display 410. Control panel 402 may be utilized by a user to display target data, e.g., target summary type, target substrates, data associated with target operations, etc. For example, control panel 402 may have a number of controls, e.g., menus, selectable lists, etc., for customizing data display 410 and/or select data displayed in data display 410. Exemplary control panel 402 includes three controls, 404, 406, and 408. More or fewer controls are considered. Possible controls may include, for example, data file selection 404, sensor selection 406, and processing procedure selection 408. In some embodiments, controls may include selecting a classification of operation (e.g., data files chosen in data file selection 404 may be separated into classes, such as first material deposition, first process gas evacuation, etc., a separate control may be provided for classification selection, or the like), selecting a type of summary data (e.g., data files may be separated into summary type, such as steady-state mean, transitory portion maximum slope, etc.), etc.

Data display 410 may display summary data such that data associated with different tiers, layers, loops, etc., may be easily distinguished. Dashboard 400 may include key 412. In some embodiments, data points associated with different layers may be displayed using a different color, e.g., a color gradient may be utilized to distinguish data from different layers. As shown in FIG. 4, different layers may be distinguished by different patterns. FIG. 4 depicts early layers (e.g., the first third) as data points with no pattern, intermediate layers as data points with a striped pattern, and late layers as data points with a hash pattern.

Data display 410 displays summary data associated with four substrates, data sets 414, 415, 416, and 417. In some embodiments, one or more data sets may be associated with a model or ideal system, e.g., golden run data, data associated with a processing procedure that produced products meeting productivity thresholds, etc. Exemplary data display 410 includes golden run data set 417.

Data display 410 may display summary data values associated with a layer (or a group of layers, e.g., boxcar averaging, etc.) and a substrate, e.g., y-axis of data display 410 may represent summary data values. Four values of summary data are marked in FIG. 4, first target value 420, second target value 422, third value 424, and fourth value 426. Data display 410 may be used to compare data associated with substrates, e.g., to compare data of processed substrates to one or more model data sets. Exemplary data displayed on dashboard 400 may target first target value 420 for early layers, and second value 422 for intermediate and late layers. Data display 410 may display data in such a way that it is easy to distinguish differences in layers between substrates—e.g., golden run data represented as data set 417 may define target values. In some embodiments, target values may be user-defined, defined by averages of multiple processing runs, etc. Data set 416 resembles data set 417, which may be indicative that data set 416 is associated with a processing procedure similar to the procedure associated with data set 417 (e.g., may be indicative of products with similar properties).

Data sets 414 and 415 include data points with values approximately corresponding to third value 424 and fourth value 426. In some embodiments, data display 410 may be configured to display data points visually distinguished by layer, e.g., data set 415 includes late layers with summary data values approximately fourth value 426, and data set 414 includes intermediate layers with summary data values of approximately third value 424 and late layers with summary data values of approximately fourth value 426. It may be quickly discerned which portions of a processing procedure may be adjusted to achieve target processing conditions.

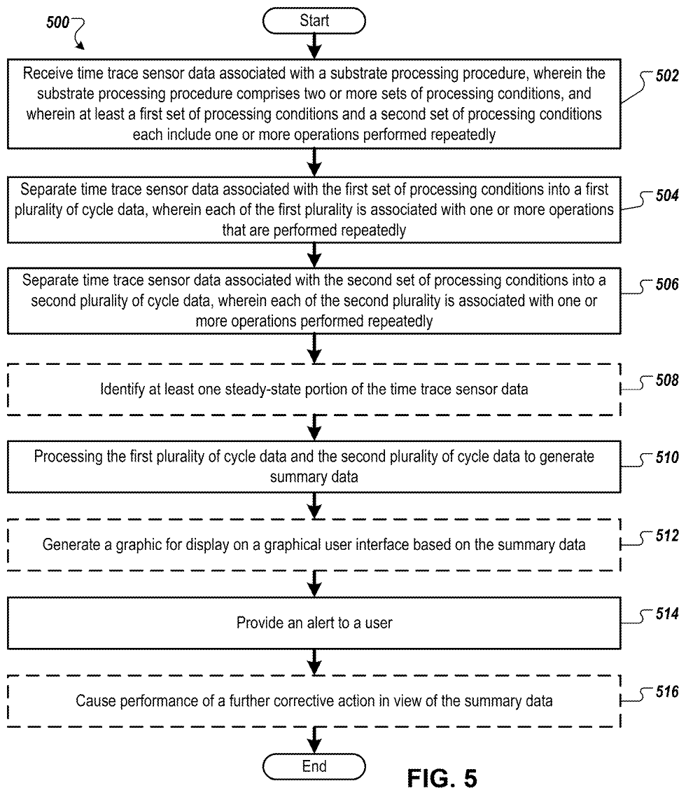

FIG. 5 depicts a flow diagram of method 500 for generating an alert based on a looped processing procedure, according to some embodiments. At block 502, processing logic receives time trace sensor data associated with a substrate processing procedure. The processing procedure includes two or more sets of processing conditions. In some embodiments, the processing procedure may be separated into runs associated with different processing conditions (e.g., higher layers of a multi-layered device may be designed differently than lower layers and be processed differently to achieve target properties). In some embodiments, the processing procedure may include one or more runs, between which the substrate may be removed from the processing environment, removed from the processing chamber, etc. In some alternative embodiments, a processing procedure may include multiple processing runs associated with the same or similar processing conditions. At least two of the processing runs (e.g., two data files, two sets of processing conditions, etc.) each include one or more operations performed repeatedly.

Repeated operations may be performed to generate a target layered structure, e.g., a three-dimensional NAND memory structure. Repeated operations may include, for example, introduction of a first process gas (e.g., for deposition of a first material on a surface of a substrate), evacuation of the first process gas, introduction of a second process gas (e.g., for deposition of a second material on a surface of the substrate), evacuation of the second process gas, etc. In some embodiments, a target structure may include alternating layers of silicon oxide and silicon nitride (e.g., the first process gas may include oxide precursors and the second process gas may include nitride precursors). In some embodiments, a target structure may include alternating layers of silicon oxide and polysilicon. In some embodiments, layers of more than two materials may be formed, e.g., the target structure may include layers of silicon oxide, silicon nitride, and polysilicon. In some embodiments, a cyclic deposition procedure may include multiple depositions of a single material, e.g., repeated polysilicon deposition operations. In some embodiments, a cyclic procedure may include multiple operations associated with multiple depositions of a material, e.g., introduction of a first process gas for deposition, evacuation of the process gas, introduction of a second process gas for further layer processing (e.g., plasma processing of the deposited material), and evacuation of the second process gas. Such multi-stage operations may be utilized for cyclic depositions of a single material, two materials, or more materials. In some embodiments, the target structure may include a large number of layers, e.g., 50 or more layers, 80 or more layers, 100 or more layers, 200 or more layers, etc. (e.g., a total number of repetitions of operations may be 50 or more, 80 or more, etc.).

At block 504, processing logic separates time trace sensor data associated with the first set of processing conditions into a first plurality of cycle data. Each of the first plurality is associated with one or more operations that are performed repeatedly. In some embodiments, each of the first plurality of cycle data may be associated with a processing operations, e.g., first material deposition, first process gas evacuation, or the like. In some embodiments, sensor data values may be utilized to distinguish operations, cycles, loops, etc. Sensor values from a number of sensors may be utilized to distinguish operations, e.g., values recorded by a processing chamber pressure sensor may be used to distinguish a deposition operations from a purge operation, values recorded by a flow meter associated with a first process gas may be used to distinguish deposition of a first material from deposition of a second material, etc. In some embodiments, each of the first plurality of cycle data may be associated with a set of operations that are each repeated, e.g., operations associated with one piece of a repeated pattern of a processed structure, such as operations associated with deposition of a first material and deposition of a second material. In some embodiments, each of the first plurality of cycle data may be associated with multiple processing loops. At block 506, processing logic separates time trace sensor data associated with the second set of processing conditions into a second plurality of cycle data. Operations of block 506 may share features with operations of block 504.

At block 508, processing logic identifies at least one steady-state portion of the time trace sensor data. In some embodiments, cycle data may be separated into transient and steady-state portions. Separation of steady-state and transient portions is discussed in more detail in connection with FIG. 3. In some embodiments, separate analysis may be performed on steady-state and transient portions. In some embodiments, analysis may only be performed on one type of portion, e.g., either steady-state or transient portions.

At block 510, processing logic processes the first plurality of cycle data and the second plurality of cycle data to generate summary data. In some embodiments, processing may be performed on a portion of cycle data, e.g., steady-state portions. Summary data may be based on one or more steady-state portions. In some embodiments, summary data may include one or more statistical metrics, e.g., mean, median, range, standard deviation, skew, etc.

At block 512, processing logic may generate a graphic for display on a graphical user interface (GUI) based on the summary data. The graphic may be included in a GUI element, e.g., the GUI may include multiple elements, one or more of which is a graphic associated with a cyclic procedure. The GUI element may include an indication of summary data associated with cycles of the first and second plurality of cycle data. The graphic for display may include a visual distinction between displayed data associated with different cycles, e.g., data may be displayed in a different color along a color gradient depending on which tier/loop the data is associated with. In some embodiments, a graphic may include data from one or more substrates. In some embodiments, a graphic may include data associated with one or more class of operations, e.g., may only include data from operations associated with deposition of a first material, etc. In some embodiments, a graphic may include data associated with a model system, e.g., output of a physics-based model, golden run sensor data, etc.

At block 514, processing logic provides an alert to a user. The alert may include the graphic of block 512. The alert may be provided via a dashboard, e.g., exemplary dashboard 400 of FIG. 4. The alert may be provided via a graphical user interface, e.g., to enable interaction by a user (e.g., data selection, visualization customization, etc.). At block 516, a performance of a further corrective action is caused in view of the summary data. A further corrective action (e.g., further to providing an alert to a user) may include scheduling maintenance, updating a process recipe, or the like.

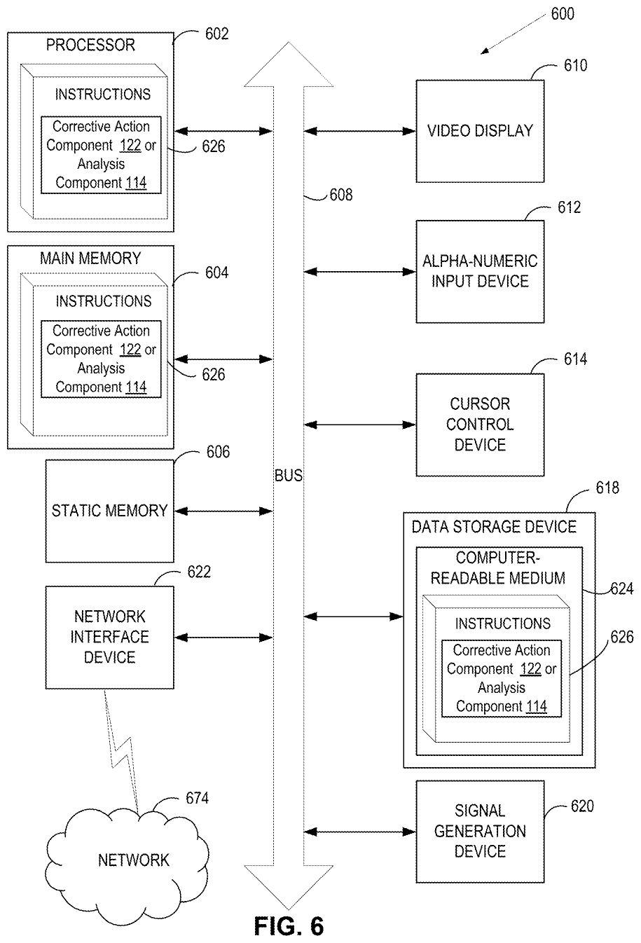

FIG. 6 is a block diagram illustrating a computer system 600, according to certain embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., analysis component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1. A method, comprising:
receiving time trace sensor data associated with a substrate processing procedure, wherein the substrate processing procedure comprises two or more sets of processing conditions, and wherein a first set of processing conditions and a second set of processing conditions of the two or more sets of processing conditions each include one or more operations performed repeatedly;
separating a first portion of the time trace sensor data corresponding to the first set of processing conditions into a first plurality of cycle data, wherein each of the first plurality of cycle data is associated with one or more operations that are performed repeatedly;
separating a second portion of the time trace sensor data corresponding to the second set of processing conditions into a second plurality of cycle data, wherein each of the second plurality is associated with one or more operations performed repeatedly;
processing the first plurality of cycle data and the second plurality of cycle data to generate summary data; and
providing, to a user, an alert that is based on the summary data.

2. The method of claim 1, further comprising:
identifying at least one steady-state portion of the time trace sensor data, wherein at least a portion of the summary data is based on the steady-state portion.

3. The method of claim 1, further comprising performing a cycle associated with the first plurality of cycle data, wherein performing the cycle associated with the first plurality of cycle data comprises:
supplying a first process gas to a processing chamber for depositing a first material on a surface of a substrate;
evacuating the first process gas from the processing chamber;
supplying a second process gas to the processing chamber for depositing a second material on the surface of the substrate; and
evacuating the second process gas from the processing chamber.

4. The method of claim 3, wherein the first material comprises silicon oxide, and wherein the second material comprises silicon nitride.

5. The method of claim 1, further comprising:
assigning a first set of index values to each of the first plurality of cycle data; and
assigning a second set of index values to each of the second plurality of cycle data, such that the first set of index values and the second set of index values comprise a unique identifier for each cycle data of the first and second pluralities of cycle data.

6. The method of claim 1, wherein the summary data comprises one or more statistical metrics.

7. The method of claim 1, further comprising providing a graphical user interface (GUI) presenting a GUI element, the GUI element comprising:
an indication of summary data associated with one or more cycles of the first plurality of cycle data and one or more cycles of the second plurality of cycle data; and
a visual distinction between each indication.

8. The method of claim 1, wherein the substrate processing procedure is to generate a three-dimensional NAND memory device.

9. The method of claim 1, wherein separating the first portion of the time trace sensor data associated with the first set of processing conditions into the first plurality of cycle data comprises identifying two or more operations of a cycle based on sensor data values associated with the two or more operations.

10. A system, comprising memory and a processing device coupled to the memory, wherein the processing device is configured to:
receive time trace sensor data associated with a substrate processing procedure, wherein the substrate processing procedure comprises two or more sets of processing conditions, and wherein a first set of processing conditions and a second set of processing conditions of the two or more sets of processing conditions each include one or more operations performed repeatedly;
separate a first portion of the time trace sensor data corresponding to the first set of processing conditions into a first plurality of cycle data, wherein each of the first plurality of cycle data is associated with one or more operations that are performed repeatedly;
separate a second portion of the time trace sensor data corresponding to the second set of processing conditions into a second plurality of cycle data, wherein each of the second plurality is associated with one or more operations performed repeatedly;
process the first plurality of cycle data and the second plurality of cycle data to generate summary data; and
provide, to a user, an alert that is based on the summary data.

11. The system of claim 10, wherein the processing device is further configured to identify at least one steady-state portion of the time trace sensor data, wherein at least a portion of the summary data is based on the steady-state portion.

12. The system of claim 10, wherein a cycle associated with the first plurality of cycle data comprises:
supplying a first process gas to a processing chamber for depositing a first material on a surface of a substrate;
evacuating the first process gas from the processing chamber;
supplying a second process gas to the processing chamber for depositing a second material on the surface of the substrate; and
evacuating the second process gas from the processing chamber.

13. The system of claim 10, wherein a total number of repetitions of operations comprising the pluralities of cycle data is at least 50.

14. The system of claim 10, wherein the summary data comprises one or more statistical metrics.

15. The system of claim 10, further comprising providing a graphical user interface (GUI) presenting a GUI element, the GUI element comprising:
an indication of summary data associated with one or more cycles of the first plurality of cycle data and one or more cycles of the second plurality of cycle data; and
a visual distinction between each indication.

16. The system of claim 10, wherein the substrate processing procedure is to generate a three-dimensional NAND memory device.

17. The system of claim 10, wherein separating time trace sensor data associated with the first set of processing conditions into a first plurality of cycle data comprises identifying that a first portion and a second portion of the time trace sensor data are associated with, respectively, a first operation and a second operation of a cycle based on sensor data values associated with first operation and the second operation.

18. A non-transitory machine-readable storage medium storing instructions which, when executed, cause a processing device to perform operations comprising:
receiving time trace sensor data associated with a substrate processing procedure, wherein the substrate processing procedure comprises two or more sets of processing conditions, and wherein a first set of processing conditions and a second set of processing conditions of the two or more sets of processing conditions each include one or more operations performed repeatedly;
separating a first portion of the time trace sensor data correspond to the first set of processing conditions into a first plurality of cycle data, wherein each of the first plurality of cycle data is associated with one or more operations that are performed repeatedly;
separating a second portion of the time trace sensor data corresponding to the second set of processing conditions into a second plurality of cycle data, wherein each of the second plurality is associated with one or more operations performed repeatedly;
processing the first plurality of cycle data and the second plurality of cycle data to generate summary data; and
providing, to a user, an alert that is based on the summary data.

19. The non-transitory machine-readable storage medium of claim 18, wherein the operations performed by the processing device further comprise identifying at least one steady-state portion of the time trace sensor data, wherein at least a portion of the summary data is based on the steady-state portion.

20. The non-transitory machine-readable storage medium of claim 18, wherein the summary data comprises one or more statistical metrics.
